(19) United States
(12) Patent Application Publication
(10) Pub. No.: US 2015/0003411 A1
(43) Pub. Date: Jan. 1, 2015

(54) METHOD AND APPARATUS FOR SELECTING HD VOICE (VOLTE) CALLS OVER CS VOICE CALLS

(71) Applicant: QUALCOMM Incorporated, San Diego, CA (US)

(72) Inventors: Manjinder Singh SANDHU, Poway, CA (US); Madhusudan Kinthada VENKATA, San Diego, CA (US); Abhinav DAYAL, San Diego, CA (US)

(73) Assignee: QUALCOMM Incorporated, San Diego, CA (US)

(21) Appl. No.: 14/172,825

(22) Filed: Feb. 4, 2014

Related U.S. Application Data
(60) Provisional application No. 61/841,256, filed on Jun. 28, 2013.

(51) Int. Cl. H04W 36/00; H04W 88/06

(52) U.S. Cl. CPC H04W 36/0022; H04W 88/06
USPC 370/331

(57) ABSTRACT

A method, an apparatus, and a computer program product for wireless communication are provided. The apparatus may include at least one processor configured to initiate a voice call using a first network, determine that a condition exists, and switch the voice call from the first network to a second network after the determination that the condition exists. The first network may be a packet-switched network, the second network may a circuit-switched network, and the condition may be that the packet-switched network has poor coverage quality. Alternatively, the first network may be a circuit-switched network, the second network may a packet-switched network, and the condition may be that the packet-switched network has improved coverage quality. Optionally, a user may be prompted to perform the switch and the user may provide an input to perform the switch. The switch may performed using SRVCC or RRC signaling.

### CROSS-REFERENCE TO RELATED APPLICATION(S)

This application claims the benefit of U.S. Provisional Application Ser. No. 61/841,256, entitled “METHOD AND APPARATUS FOR SELECTING HD VOICE (VOLTE) CALLS OVER CS VOICE CALLS” and filed on Jun. 28, 2013, which is expressly incorporated by reference herein in its entirety.

### BACKGROUND

1. Field

The present disclosure relates generally to communication systems, and more particularly, to a method and apparatus for selecting between circuit-switched and packet-switched networks.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus may be a user equipment (UE). The UE may initiate a voice call using a first network, determine that a condition exists, and switch the voice call from the first network to a second network after the determination that the condition exists. In some configurations, the first network is a packet-switched network and the second network is a circuit-switched network. In some other configurations, the first network is a packet-switched network and the second network is a circuit-switched network.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a first diagram illustrating exemplary methods.

FIG. 7B is a diagram illustrating various battery powers of the UE.

FIG. 7C is a diagram illustrating transmission powers to various networks.

FIG. 8A is a second diagram illustrating exemplary methods.

FIGS. 8B and 8C are diagrams illustrating coverage qualities of various networks at various times.

FIG. 9 is a first flow chart of exemplary methods.

FIG. 10 is a second flow chart of exemplary methods.

FIG. 11 is a third flow chart of exemplary methods.

FIG. 12 is a conceptual data flow diagram illustrating the data flow between different modules/means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

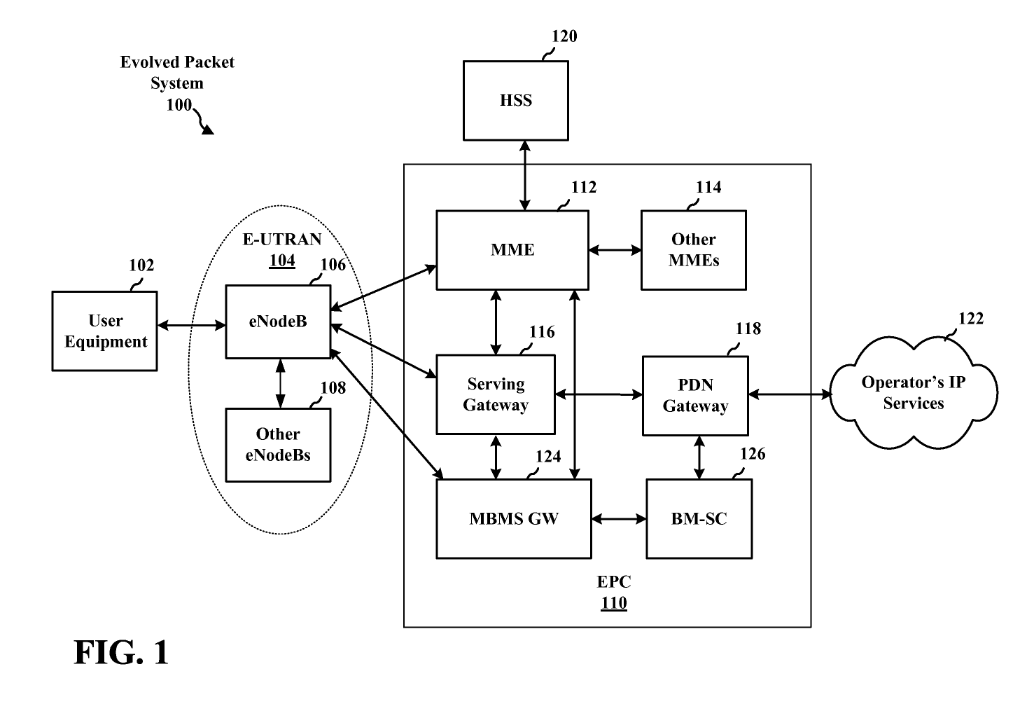

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

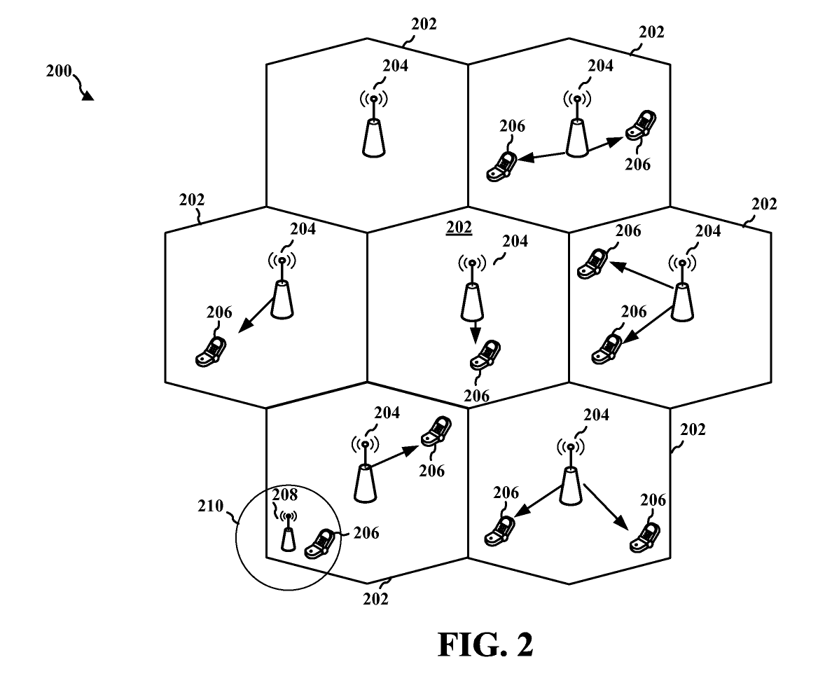

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

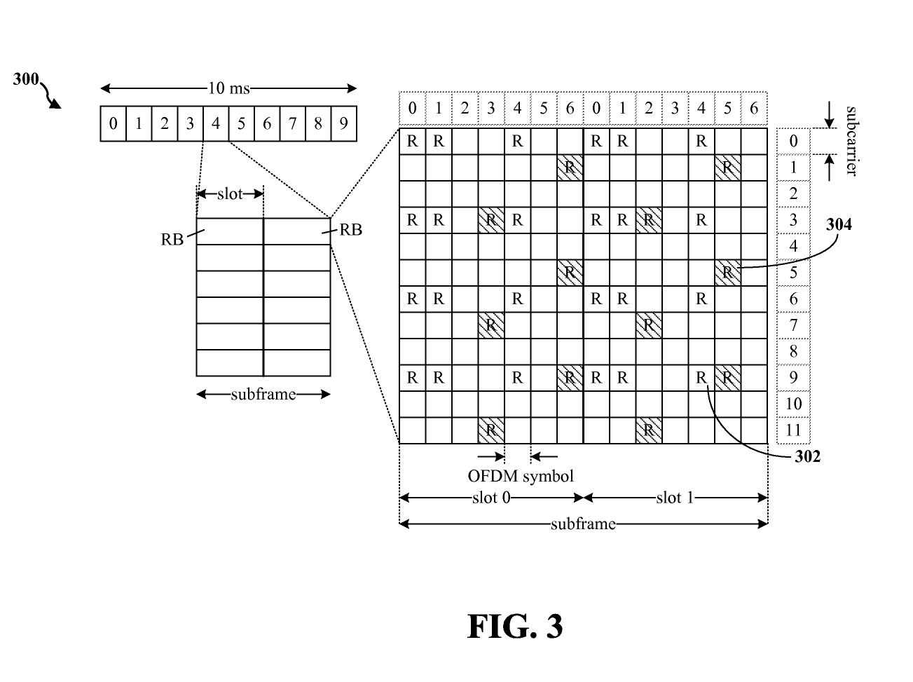

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

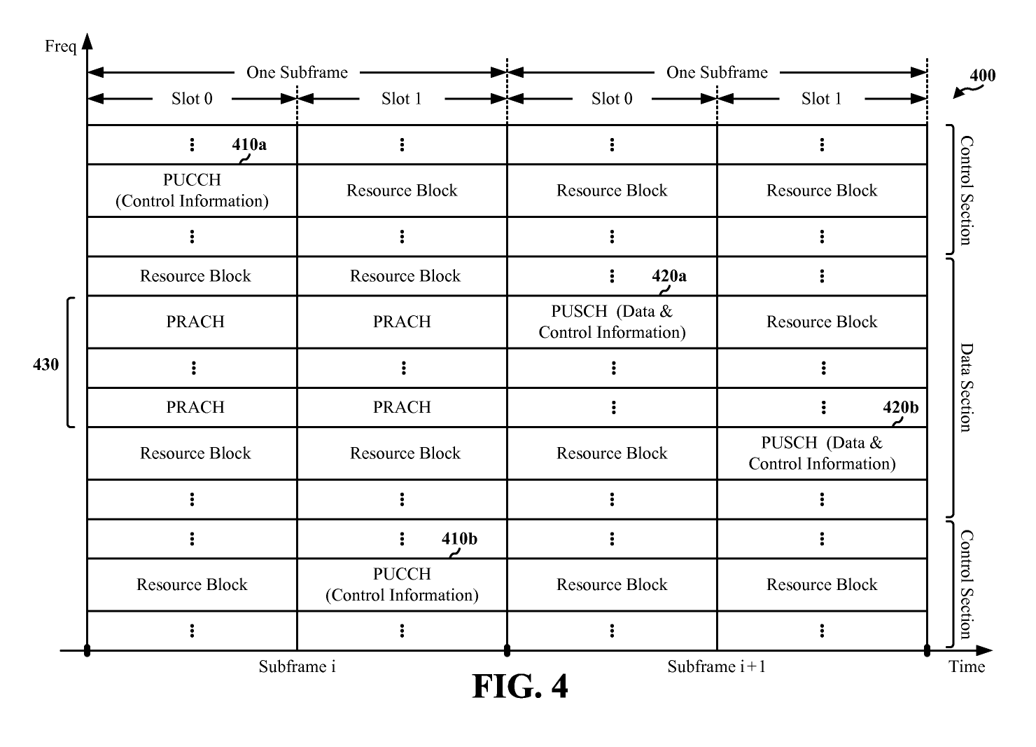

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

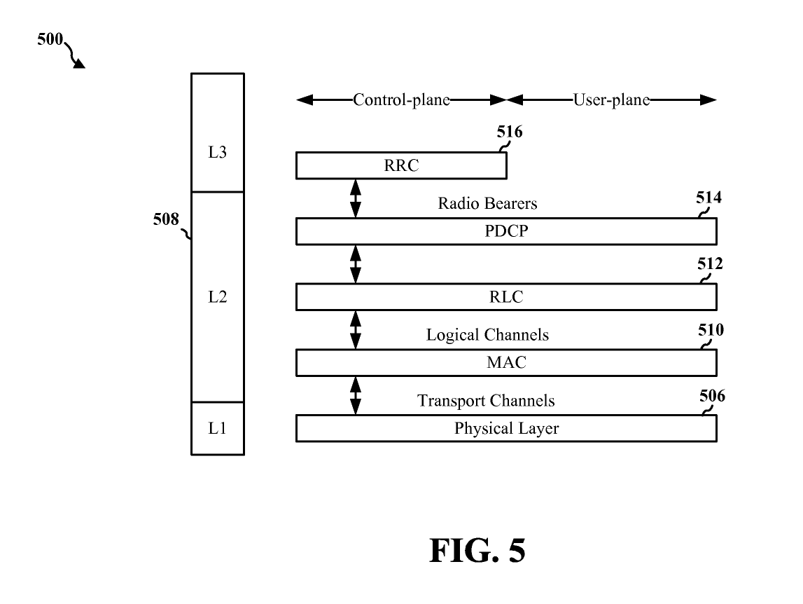

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

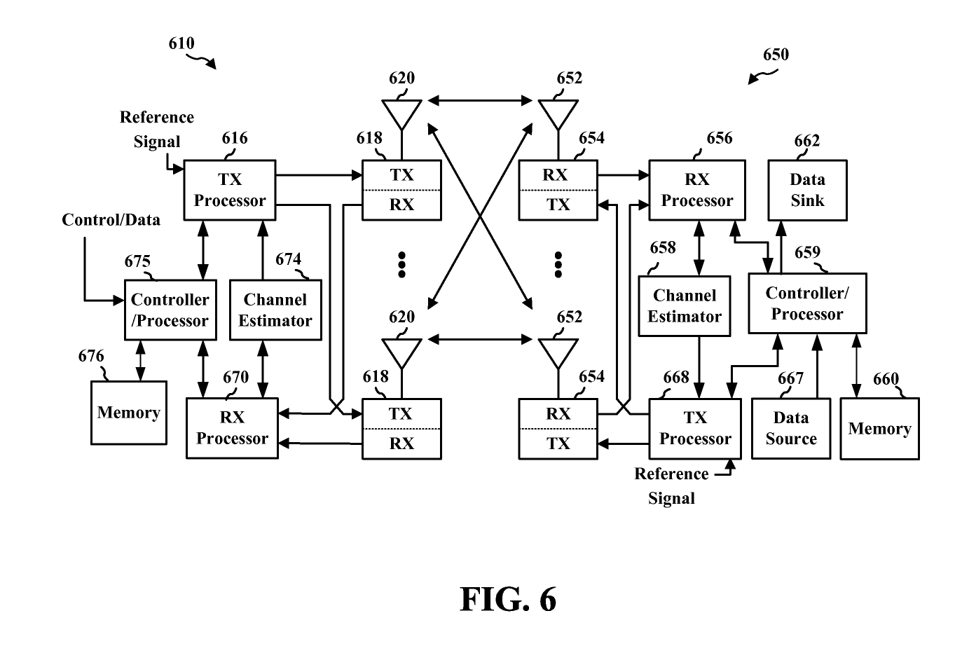

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

UEs may be capable of making voice calls over packet-switched networks (e.g., LTE) and circuit-switched networks (e.g., 1xRTT, 2G, 3G). Carriers may deploy an Internet protocol multimedia subsystem (IMS) network for voice calls over an LTE network. Such deployments may sometimes be referred to as voice-over-LTE (VoLTE) voice calls. Voice calls using packet-switched networks (e.g., LTE) may have higher voice call quality relative to voice calls using circuit-switched networks (e.g., 1xRTT, 2G, 3G) due, in part, to the availability of greater bandwidth and bit rates in packet-switched networks relative to circuit-switched networks. Packet-switched networks may provide high-definition (HD) voice call quality, while circuit-switched networks may provide standard-definition (SD) voice call quality. Accordingly, there may be a strong preference to perform a voice call using a packet-switched network. However, for example with respect to an LTE network, IMS network coverage for VoLTE voice calls may not always be available. Thus, in some circumstances, the packet-switched network may be unavailable for the voice call, and the UE may need to switch the voice call from the packet-switched network to the circuit-switched network. In other circumstances, while in a voice call over the circuit-switched network, the packet-switched network may subsequently become available, and the UE may switch from the circuit-switched network to the packet-switched network to provide higher voice call quality. Accordingly, there is a need in the art for the UE to make a determination to switch the voice call between packet-switched and circuit-switched networks based on various conditions.

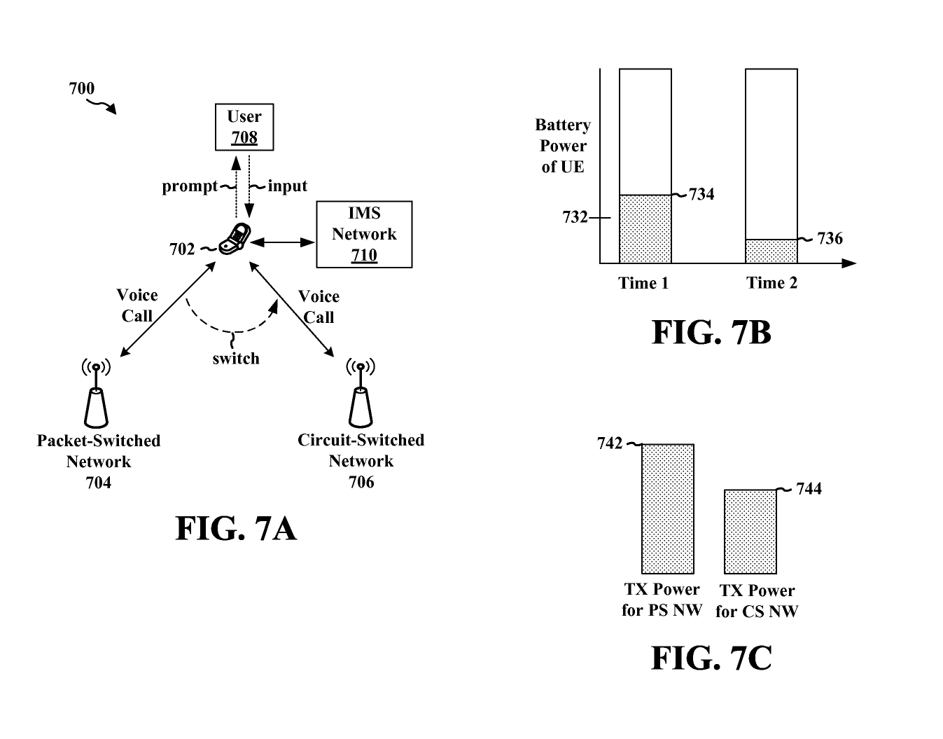

FIG. 7A is a first diagram 700 illustrating exemplary methods. The UE 702 may initiate a voice call using the packet-switched network 704, determine that a condition exists, and switch the voice call from the packet-switched network 704 to the circuit-switched network 706 after determining that the condition exists.

In one aspect, the condition is that the packet-switched network 704 has poor coverage quality. After determining that the packet-switched network 704 has poor coverage quality, the UE 702 may prompt a user 708 to switch the voice call from the packet-switched network 704 to the circuit-switched network 706. After the UE 702 receives an input from the user 708 to switch the voice call from the packet-switched network 704 to the circuit-switched 706 network, the voice call is switched 712. Switching the voice call from the packet-switched 704 network to the circuit-switched network 706 may be performed using single radio voice call continuity (SRVCC) signaling.

However, prompting the user 708 and receiving an input from the user 708 prior to performing the switch are optional. For example, the voice call may be switched from the packet-switched network 704 to the circuit-switched network 706 without prompting the user 708 or receiving an input from the user 708.

In another aspect, the UE 702 may be deregistered from the IMS network 710 when the voice call is initiated using the packet-switched network 704. In some configurations, when the UE 702 is deregistered from the IMS network 710, the UE 702 may initiate subsequent voice calls via the packet-switched network 704 until the UE is registered with the IMS network 710. In some other configurations, when the UE 702 is deregistered from the IMS network 710, the UE 702 may initiate subsequent voice calls via the circuit-switched network 706 after the voice call using the packet-switched network 704 is dropped.

In yet another aspect, the UE 702 may initiate a voice call using the packet-switched network 704 when the packet-switched network 704 has poor coverage quality. For example, poor coverage quality may exist when a reference signal received quality (RSRQ) value is 15 or lower. As another example, poor coverage quality may exist when a block error rate (BLER) value is higher than a threshold value. After a radio link failure (RLF) occurs during the voice call using the packet-switched network 704, the UE 702 may initiate subsequent voice calls via the circuit-switched network 706.

FIG. 7B is a diagram illustrating various battery powers of the UE. The UE 702 may determine that a battery power level of the UE 702 is lower than a threshold power level. For example, referring to FIG. 7B, the threshold power level is at level 732. At Time 1, the power level of the UE is at level 734, which is greater than the threshold power level. At Time 2, the power level of the UE is at level 736, which is lower than the threshold power level. When the battery power level of the UE 702 is lower than the threshold power level, the UE 702 may disable all data services other than the voice call. The UE 702 may also determine that no data activity other than the voice call is being conducted.

FIG. 7C is a diagram illustrating transmission powers to various networks. After determining that no data activity other than the voice call is conducted, the UE 702 may determine the transmission power needed for the packet-switched network and the transmission power needed for the circuit-switched network. For example, referring to FIG. 7C, the transmission power needed for the packet-switched network (PS NW) is at level 742. The transmission power needed for the circuit-switched network (CS NW) is at level 744. In some configurations, the condition may be that the transmission power needed for the circuit-switched network is less than the power needed for the packet-switched network. Accordingly, when this condition is met, the UE 702 may switch from the packet-switched network 704 to the circuit-switched network 706.

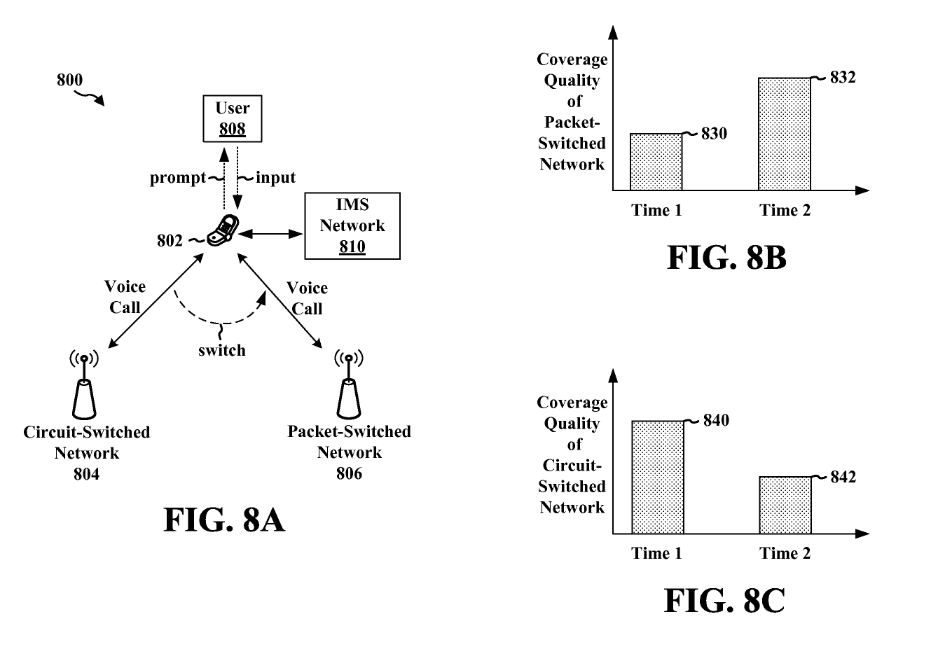

FIG. 8A is a second diagram illustrating exemplary methods. The UE 802 may initiate a voice call using the circuit-switched network 804, determine that a condition exists, and switch the voice call from the circuit-switched network 804 to the packet-switched network 806 after determining that the condition exists.

In one aspect, the condition is that the voice call initiated using the circuit-switched network 804 is dropped and that the UE 802 is registered to the IMS network 810. Accordingly, when this condition is met, the UE 802 may switch the voice call from the circuit-switched network 804 to the packet-switched network 806.

FIG. 8B is a diagram illustrating coverage quality of the packet-switched network at various times. In an aspect, the condition is that the packet-switched network has improved coverage quality. The packet-switched network may have increased coverage quality when RSRQ increases and/or BLER decreases. The coverage quality of the packet-switched network is at level 830 at Time 1. At Time 2, the coverage quality of the packet-switched network is at level 832, which is higher than level 830. Accordingly, the coverage quality of the packet-switched network has improved from Time 1 to Time 2. Accordingly, when the coverage quality of the packet-switched network improves, the UE may switch the voice call from the circuit-switched network to the packet-switched network. The voice call may be switched using RRC signaling.

FIG. 8C is a diagram illustrating coverage quality of the circuit-switched network at various times. In an aspect, the condition is that the circuit-switched network has decreased coverage quality. The circuit-switched network may have decreased coverage quality when RSRQ decreases and/or BLER increases. For example, referring to FIG. 8C, the coverage quality of the circuit-switched network is at level 840 at Time 1. At Time 2, the coverage quality of the circuit-switched network is at level 842, which is lower than level 840. Accordingly, the coverage quality of the circuit-switched network has decreased from Time 1 to Time 2. Referring to FIG. 8A, when the coverage quality of the circuit-switched network 804 decreases, the UE 802 may prompt a user to switch the voice call from the circuit-switched network 804 to the packet-switched network 806. The UE 802 may receive an input from the user to switch the voice call from the circuit-switched network 804 to the packet-switched network 806. After the user input is received, the UE 802 may switch the voice call from the circuit-switched network 804 to the packet-switched network 806.

However, prompting the user 808 and receiving an input from the user 808 prior to performing the switch are optional. For example, the voice call may be switched from the circuit-switched network 804 to the packet-switched network 806 without prompting the user 808 or receiving an input from the user 808.

In another aspect, referring to FIG. 8A, the condition is that the circuit-switched network 804 has decreased coverage quality and the packet-switched network 806 becomes available for the voice call. Although the packet-switched network 806 may be unavailable when the voice call is initiated using the circuit-switched network 804, the packet-switched network 806 may subsequently become available for the voice call. When the coverage quality of the circuit-switched network 804 decreases (as described in greater detail supra) and the packet-switched network 806 becomes available, the UE 802 may switch the voice call from the circuit-switched network 804 to the packet-switched network 806.

In yet another aspect, the condition is that the voice call initiated using the circuit-switched network 804 is dropped and the UE 802 is registered to the IMS network 810. Accordingly, when this condition is met, the UE 802 may switch from the circuit-switched network 804 to the packet-switched network 806.

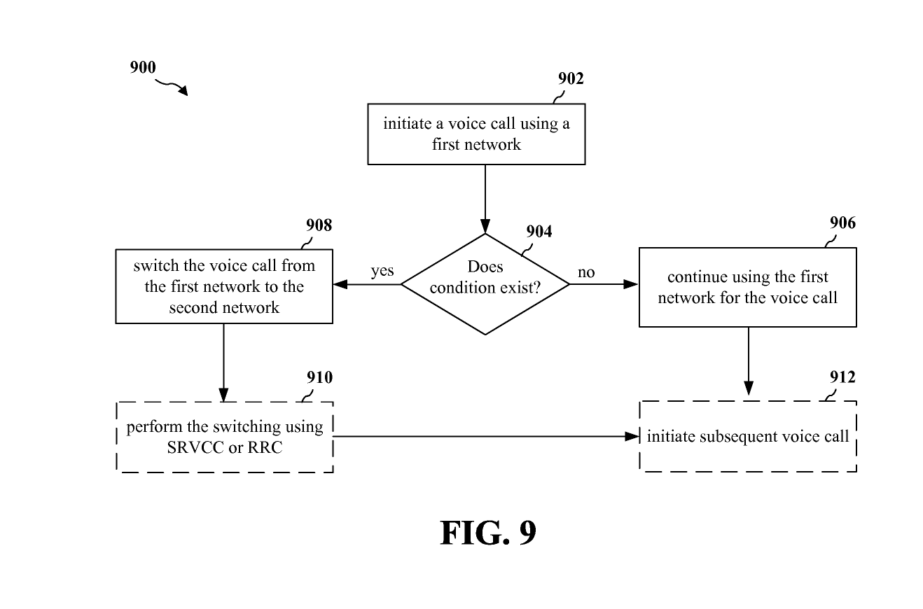

FIG. 9 is a first flow chart of exemplary methods. The methods may be performed by a UE. At step 902, the UE may initiate a voice call using a first network. At step 904, the UE may determine whether a condition exists. If the condition does not exist, at 906, the UE may continue using the first network for the voice call. If the condition does exist, at 908, the UE may switch the voice call from the first network to the second network. In some configurations, as illustrated in FIG. 7A, the first network is a packet-switched network 704, and the second network is a circuit-switched network 706. In some other configurations, as illustrated in FIG. 8A, the first network is a circuit-switched network 804, and the second network is a packet-switched network 806.

In some configurations, the condition may be that the packet-switched network has improved coverage quality. The packet-switched network may have increased coverage quality when RSRQ increases and/or BLER decreases. For example, referring to FIG. 8B, the coverage quality of the packet-switched network 806 is at level 830 at Time 1. At Time 2, the coverage quality of the packet-switched network 806 is at level 832, which is higher than level 830. Accordingly, the coverage quality of the packet-switched network 806 has improved from Time 1 to Time 2. Accordingly, when the coverage quality of the packet-switched network 806 improves, the UE 802 may switch the voice call from the circuit-switched network 804 to the packet-switched network 806.

In some configurations, the condition is that the circuit-switched network has decreased coverage quality and the packet-switched network becomes available for the voice call. For example, referring to FIG. 8A, the packet-switched network 806 may be unavailable when the voice call is initiated using the circuit-switched network 804. After the voice call is initiated using the circuit-switched network 804, the packet-switched network 806 may become available for the voice call. The circuit-switched network 804 may have decreased coverage quality when RSRQ decreases and/or BLER increases. For example, referring to FIG. 8C, the coverage quality of the circuit-switched network 804 is at level 840 at Time 1. At Time 2, the coverage quality of the circuit-switched network 804 is at level 842, which is lower than level 840. When the coverage quality of the circuit-switched network 806 has decreased from Time 1 to Time 2. When the coverage quality of the circuit-switched network 804 decreases and the packet-switched network 806 becomes available, the UE 802 may switch the voice call from the circuit-switched network 804 to the packet-switched network 806.

In some configurations, the condition is that the voice call initiated using the circuit-switched network is dropped and that the UE is registered to an IMS network. For example, referring to FIG. 8A, the UE 802 may initiate a call using the circuit-switched network 804. The UE 802 may determine whether the UE 802 is registered to the IMS network 810. If the voice call initiated using the circuit-switched network 804 is dropped and the UE 802 is registered to the IMS network 810, then the UE 802 may switch the voice call from the circuit-switched network 804 to the packet-switched network 806.

Referring to FIG. 9, at 910, the UE may perform the switching from the first network to the second network using SRVCC signaling or RRC signaling. In some configurations, referring to FIG. 7A, the UE 702 may switch the voice call from the packet-switched network 704 to the circuit-switched network 706 using SRVCC signaling. In some configurations, referring to FIG. 8A, the UE 802 may switch the voice call from the circuit-switched network 804 to the packet-switched network 806 using RRC signaling.

Referring to FIG. 9, at 912, the UE may initiate subsequent voice calls. For example, referring to FIG. 7A, the UE 702 may be deregistered from the IMS network 710 when the voice call is initiated using the packet-switched network 704. In some configurations, when the UE 702 is deregistered from the IMS network 710, the UE 702 may initiate subsequent voice calls via the packet-switched network 704 until the UE is registered with the IMS network 710. In some other configurations, when the UE 702 is deregistered from the IMS network 710, the UE 702 may initiate subsequent voice calls via the circuit-switched network 706 after the voice call using the packet-switched network 704 is dropped. In yet other configurations, the UE 702 may initiate subsequent voice calls via the circuit-switched network 706 after a radio link failure (RLF) occurs during the voice call using the packet-switched network 704.

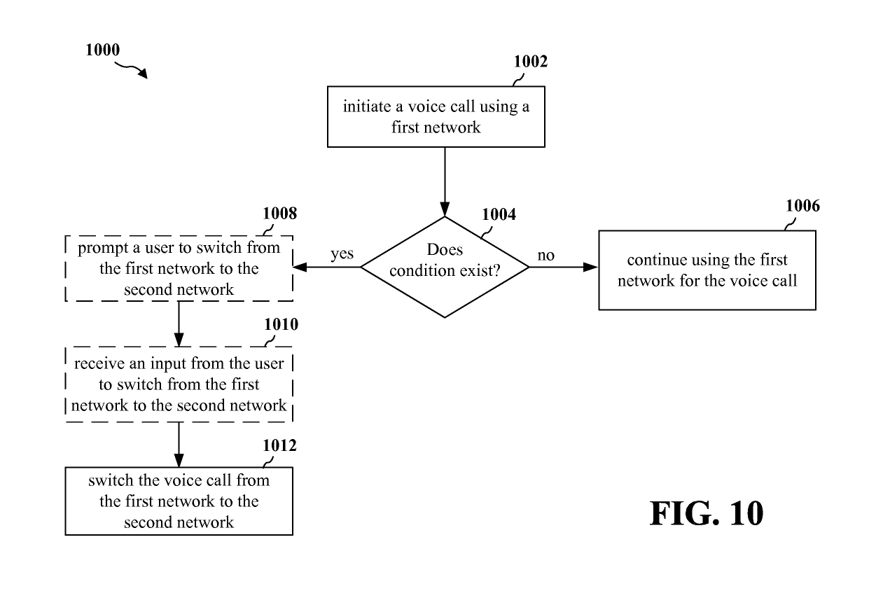

FIG. 10 is a second flow chart of exemplary methods. At 1002, the UE may initiate a voice call using a first network. At 1004, the UE may determine whether a condition exists, as described in greater detail supra. If the condition does not exist, at 1006, the UE continues to use the first network for the voice call. Alternatively, if the condition does exist, at 1008, the UE may prompt the user to switch from the first network to the second network. Further, at 1010, the UE may receive an input from the user to switch from the first network to the second network. However, as described supra, one of ordinary skill in the art will appreciate that prompting a user and receiving an input from the user prior to performing the switch are optional.

In some configurations, referring to FIG. 7A, the condition may be that the packet-switched network 704 has poor coverage quality. For example, poor coverage quality may exist when the RSRQ value is 15 or lower. As another example, poor coverage quality may exist when the BLER value is higher than a threshold value. If the packet-switched network 704 has poor coverage quality, the UE 702 may prompt a user 708 to switch the voice call from the packet-switched network 704 to the circuit-switched network 706. Further, the UE 702 may receive an input from the user 708 to switch the voice call from the packet-switched network 704 to the circuit-switched network 706.

In some configurations, referring to FIG. 8A, the condition may be that the packet-switched network 806 has improved coverage quality. For example, improved coverage quality may exist when RSRQ increases and/or BLER decreases. For example, referring to FIG. 8B, the coverage quality of the packet-switched network 806 is at level 830 at Time 1. At Time 2, the coverage quality of the packet-switched network 806 is at level 832, which is higher than level 830. Accordingly, the coverage quality of the packet-switched network 806 has improved from Time 1 to Time 2. If the packet-switched network 806 has improved coverage quality, the UE 802 may prompt the user 808 to switch the voice call from the circuit-switched network 804 to the packet-switched network 806. Further, the UE 802 may receive an input from the user 808 to switch the voice call from the circuit-switched network 804 to the packet-switched network 806.

After the UE receives an input from the user to switch from the first network to the second network, at 1012, the UE may switch the voice call from the first network to the second network, as described in greater detail supra.

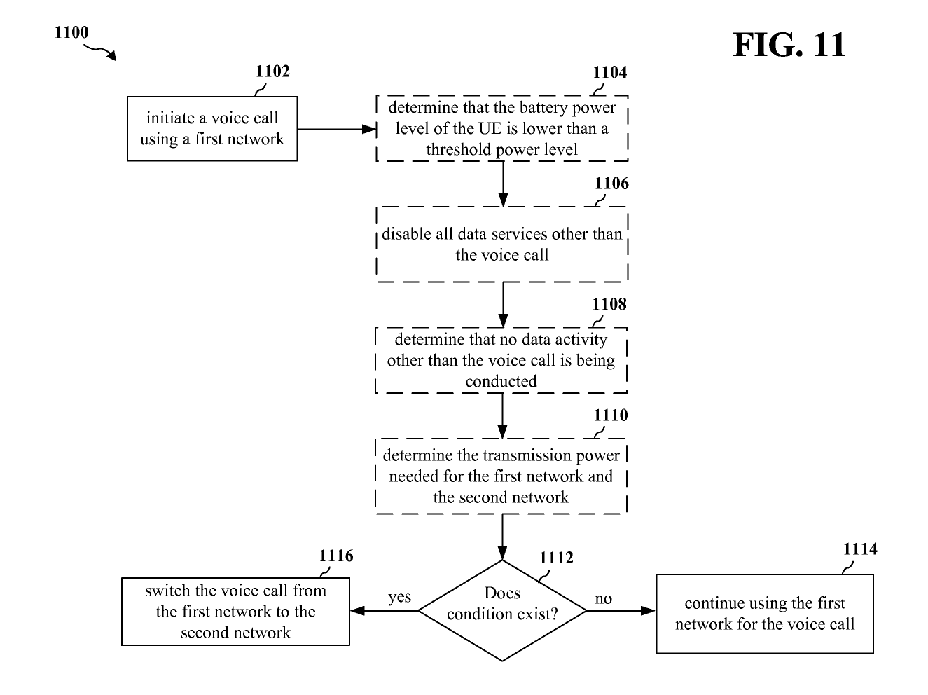

FIG. 11 is a third flow chart of exemplary methods. At 1102, the UE may initiate a voice call using a first network. At 1104, the UE may determine that the battery power level of the UE is lower than the threshold power level. For example, referring to FIG. 7B, the threshold power level is at level 732. At Time 2, the power level of the UE is at level 736, which is lower than the threshold power level. Accordingly, at Time 2, the UE may determine that the battery power level of the UE is lower than the threshold power level.

At 1106, the UE may disable all data services other than the voice call when the battery power level of the UE is lower than the threshold power level. At 1108, the UE may determine that no data activity other than the voice call is being conducted. After determining that no data activity other than the voice call is conducted, at 1110, the UE may determine the transmission power needed for the first network and the transmission power needed for the second network. For example, referring to FIG. 7C, the transmission power needed for the packet-switched network is at level 742. The transmission power needed for the circuit-switched network is at level 744. In this example, the transmission power needed for the circuit-switched network is less than the transmission power needed for the packet-switched network.

At 1112, UE determines whether a condition exists. If the condition does not exist, at 1114, the UE continues using the first network for the voice call. Alternatively, if the condition does exist, at 1116, the UE switches the voice call from the first network to the second network. In some configurations, referring to FIG. 7C, the condition may be that the transmission power needed for the circuit-switched network 706 is less than the transmission power needed for the packet-switched network 704. Accordingly, when the transmission power needed for the circuit-switched network 706 is less than the transmission power needed for the packet-switched network 704, the UE 702 may switch from the packet-switched network 704 to the circuit-switched network 706.

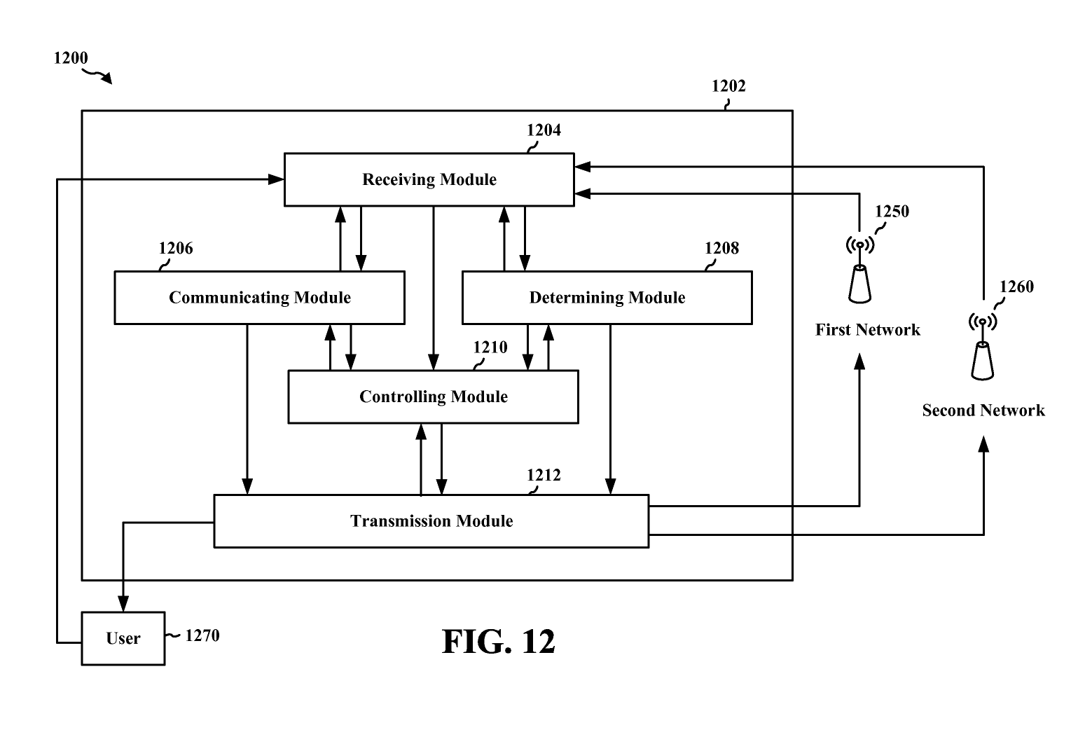

FIG. 12 is a conceptual data flow diagram 1200 illustrating the data flow between different modules/means/components in an exemplary apparatus 1202. The apparatus 1202 may be a UE. The apparatus includes a receiving module 1204, a communicating module 1206, a determining module 1208, a controlling module 1210, and a transmission module 1212.

The communication module 1206 may be configured to initiate a voice call using the first network 1250. The determining module 1208 may be configured to determine that a condition exists. The controlling module 1210 may be configured to switch the voice call from the first network 1250 to the second network 1260 after the determination that the condition exists.

In some configurations, the first network 1250 is a packet-switched network and the second network 1260 is a circuit-switched network. The determining module 1208 may be further configured to determine that the battery power level of the UE is lower than a threshold power level. The controlling module 1210 may be further configured to disable all data services other than the voice call when the battery power level of the UE is lower than the threshold power level. The determining module 1208 may be further configured to determine that no data activity other than the voice call is being conducted. The determining module 1208 may be further configured to determine that a first transmission power needed for the packet-switched network and a second transmission power needed for the circuit-switched network after determining that no data activity other than the voice call is being conducted. In such configurations, the condition may be that the second transmission power is less than the first transmission power.

In some configurations, the first network 1250 is a circuit-switched network, the second network 1260 is a packet-switched network, and the condition is that the packet-switched network has improved coverage quality. The transmission module 1212 may be configured to prompt the user 1270 to switch the voice call from the circuit-switched network to the packet-switched network after the determination that the condition exists. The receiving module 1204 may be configured to receive an input from the user 1270 to switch the voice call from the circuit-switched network to the packet-switched network. The controlling module 1210 may be further configured to perform the switching after the input from the user 1270 is received.

In some configurations, the first network 1250 is a circuit-switched network, the second network 1260 is a packet-switched network, and the condition is that the packet-switched network has improved coverage quality. The controlling module 1210 may be further configured to perform the switching of the voice call from the circuit-switched network to the packet-switched network RRC signaling.

In some configurations, the first network 1250 is a circuit-switched network, the second network 1260 is a packet-switched network, the packet-switched network is unavailable for the voice call when the voice call is initiated using the circuit-switched network, and the condition is that the circuit-switched network has decreased coverage quality and the packet-switched network becomes available for the voice call.

In some configurations, the first network 1250 is a circuit-switched network, the second network 1260 is a packet-switched network, and the condition is that the voice call initiated using the circuit-switched network is dropped and that the UE is registered to the IMS network.

In some configurations, the UE is deregistered from the IMS network when the voice call is initiated using the first network 1250, and the communicating module 1206 is further configured to initiate subsequent voice calls via the first network until the UE is registered with the IMS network.

In some configurations, UE is deregistered from the IMS network when the voice call is initiated using the first network 1250, and the communicating module 1210 is further configured to initiate subsequent voice calls via the second network 1260 after the voice call using the first network 1250 is dropped.

In some configurations, the voice call initiated using the first network 1250 has poor coverage quality, and the communicating module 1210 is further configured to initiate subsequent voice calls via the second network 1260 after the RLF occurs during the voice call.

In some configurations, the first network 1250 is a packet-switched network, the second network 1260 is a circuit-switched network, and the condition is that the packet-switched network has poor coverage quality. The transmission module 1212 may be further configured to prompt the user 1270 to switch the voice call from the packet-switched network to the circuit-switched network after the determination that the condition exists. The receiving module 1204 may be further configured to receive an input from the user 1270 to switch the voice call from the packet-switched network to the circuit-switched network. The controlling module 1210 is further configured to switch the voice call from the packet-switched network to the circuit-switched network after the user input is received and to perform the switching via SRVCC signaling.

The apparatus may include additional modules that perform each of the steps of the algorithm in the aforementioned flow charts of FIGS. 9-11. As such, each step in the aforementioned flow charts of FIGS. 9-11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

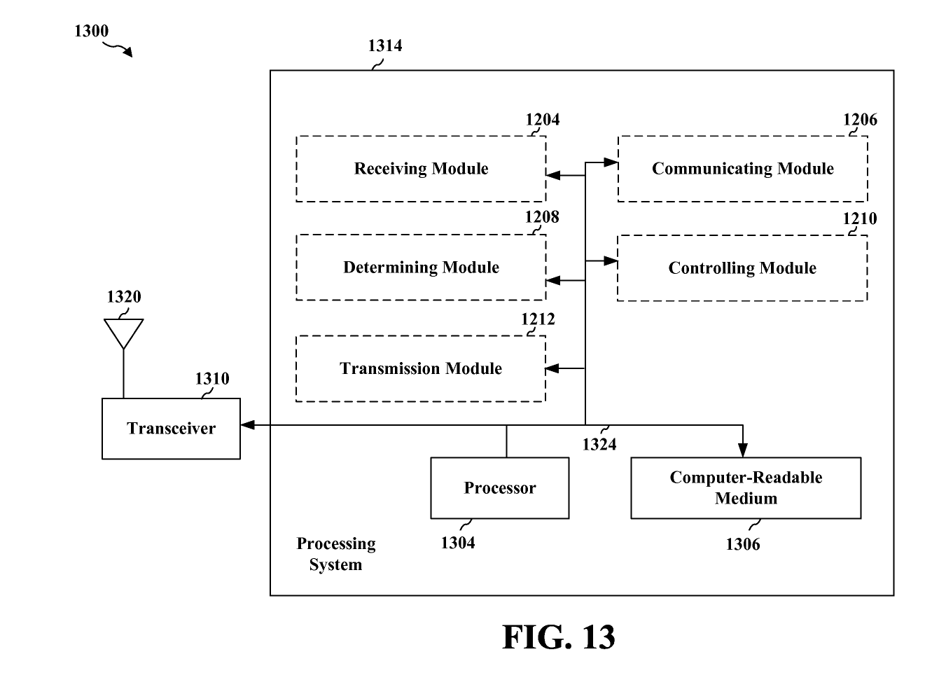

FIG. 13 is a diagram illustrating an example of a hardware implementation for an apparatus 1300 employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, 1208, 1210, 1212 and the computer-readable medium 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the receiving module 1204. In addition, the transceiver 1310 receives information from the processing system 1314, specifically the transmission module 1212, and based on the received information, generates a signal to be applied to the one or more antennas 1320. The processing system 1314 includes a processor 1304 coupled to a computer-readable medium 1306. The processor 1304 is responsible for general processing, including the execution of software stored on the computer-readable medium 1306. The software, when executed by the processor 1304, causes the processing system 1314 to perform the various functions described supra for any particular apparatus. The computer-readable medium 1306 may also be used for storing data that is manipulated by the processor 1304 when executing software. The processing system further includes at least one of the modules 1204, 1206, 1208, 1210, and 1212. The modules may be software modules running in the processor 1304, resident/stored in the computer readable medium 1306, one or more hardware modules coupled to the processor 1304, or some combination thereof. The processing system 1314 may be a component of the UE 650 and may include the memory 660 and/or at least one of the TX processor 668, the RX processor 656, and the controller/processor 659.

In one configuration, the apparatus 1202/1300 for wireless communication may be a UE. The UE includes means for initiating a voice call using a first network. The UE may also include means for determining that a condition exists. The UE may also include means for switching the voice call from the first network to a second network after the determination that the condition exists. The UE may also include means for determining that a battery power level of the UE is lower than a threshold power level. The UE may also include means for disabling all data services other than the voice call when the battery power level of the UE is lower than the threshold power level. The UE may also include means for determining that no data activity other than the voice call is being conducted. The UE may also include means for determining a first transmission power needed for the packet-switched network and a second transmission power needed for the circuit-switched network after determining that no data activity other than the voice call is being conducted. The UE may also include means for prompting a user to switch the voice call from the circuit-switched network to the packet-switched network after the determination that the condition exists. The UE may also include means for receiving an input from the user to switch the voice call from the circuit-switched network to the packet-switched network. The UE may also include means for the switching the voice call from the circuit-switched network to the packet-switched network is using RRC signaling. The UE may also include means for initiating subsequent voice calls via the first network until the UE is registered with the IMS network. The UE may also include means for initiating subsequent voice calls via the second network after the voice call using the first network is dropped. The UE may also include means for initiating subsequent voice calls via the second network after RLF occurs during the voice call. The UE may also include means for prompting a user to switch the voice call from the packet-switched network to the circuit-switched network after the determination that the condition exists. The UE may also include means for receiving an input from the user to switch the voice call from the packet-switched network to the circuit-switched network. The UE may also include means for switching the voice call from the packet-switched network to the circuit-switched network via SRVCC signaling.

The aforementioned means may be one or more of the aforementioned modules of the apparatus 1202 and/or the processing system 1314 of the apparatus 1300 configured to perform the functions recited by the aforementioned means. As described supra, the processing system 1314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication by a user equipment (UE), the method comprising:
initiating a voice call using a first network;
determining that a condition exists; and
switching the voice call from the first network to a second network after the determination that the condition exists.

2. The method of claim 1, wherein the first network is a packet-switched network and the second network is a circuit-switched network, the method further comprising:
determining that a battery power level of the UE is lower than a threshold power level;
disabling all data services other than the voice call when the battery power level of the UE is lower than the threshold power level;
determining that no data activity other than the voice call is being conducted; and
determining a first transmission power needed for the packet-switched network and a second transmission power needed for the circuit-switched network after determining that no data activity other than the voice call is being conducted,
wherein the condition comprises the second transmission power being less than the first transmission power.

3. The method of claim 1, wherein the first network is a circuit-switched network, the second network is a packet-switched network, and the condition comprises the packet-switched network having improved coverage quality, the method further comprising:
prompting a user to switch the voice call from the circuit-switched network to the packet-switched network after the determination that the condition exists; and
receiving an input from the user to switch the voice call from the circuit-switched network to the packet-switched network,
wherein the switching the voice call from the circuit-switched network to the packet-switched network occurs after the user input is received.

4. The method of claim 1, wherein:
the first network is a circuit-switched network and the second network is a packet-switched network;
the condition comprises the packet-switched network having improved coverage quality; and
the switching the voice call from the circuit-switched network to the packet-switched network is performed using radio resource control (RRC) signaling.

5. The method of claim 1, wherein the first network is a circuit-switched network and the second network is a packet-switched network, and wherein:
the packet-switched network is unavailable for the voice call when the voice call is initiated using the circuit-switched network; and
the condition comprises the circuit-switched network having a decreased coverage quality and the packet-switched network becoming available for the voice call.

6. The method of claim 1, wherein the first network is a circuit-switched network and the second network is a packet-switched network, and wherein the condition comprises:
the voice call initiated using the circuit-switched network being dropped; and
the UE being registered to an Internet protocol multimedia subsystem (IMS) network.

7. The method of claim 1, wherein the UE is deregistered from an Internet protocol multimedia subsystem (IMS) network when the voice call is initiated using the first network, the method further comprising:
initiating subsequent voice calls via the first network until the UE is registered with the IMS network.

8. The method of claim 1, wherein the UE is deregistered from an Internet protocol multimedia subsystem (IMS) network when the voice call is initiated using the first network, the method further comprising:
initiating subsequent voice calls via the second network after the voice call using the first network is dropped.

9. The method of claim 1, wherein the voice call is initiated using the first network having poor coverage quality, the method further comprising:
initiating subsequent voice calls via the second network after a radio link failure (RLF) occurs during the voice call.

10. The method of claim 1, wherein the first network is a packet-switched network, the second network is a circuit-switched network, and the condition comprises the packet-switched network having poor coverage quality, the method further comprising:
prompting a user to switch the voice call from the packet-switched network to the circuit-switched network after the determination that the condition exists; and
receiving an input from the user to switch the voice call from the packet-switched network to the circuit-switched network, wherein the switching the voice call from the packet-switched network to the circuit-switched network occurs after the user input is received and is performed via single radio voice call continuity (SRVCC) signaling.

11. An apparatus for wireless communication by a user equipment (UE), the apparatus comprising:
means for initiating a voice call using a first network;
means for determining that a condition exists; and
means for switching the voice call from the first network to a second network after the determination that the condition exists.

12. The apparatus of claim 11, wherein the first network is a packet-switched network and the second network is a circuit-switched network, the apparatus further comprising:
means for determining that a battery power level of the UE is lower than a threshold power level;
means for disabling all data services other than the voice call when the battery power level of the UE is lower than the threshold power level;
means for determining that no data activity other than the voice call is being conducted; and
means for determining a first transmission power needed for the packet-switched network and a second transmission power needed for the circuit-switched network after the means for determining determines that no data activity other than the voice call is being conducted,
wherein the condition comprises the second transmission power being less than the first transmission power.

13. The apparatus of claim 11, wherein the first network is a circuit-switched network, the second network is a packet-switched network, and the condition comprises the packet-switched network having improved coverage quality, the apparatus further comprising:
means for prompting a user to switch the voice call from the circuit-switched network to the packet-switched network after the determination that the condition exists; and
means for receiving an input from the user to switch the voice call from the circuit-switched network to the packet-switched network,
wherein the means for switching is configured to switch the voice call from the circuit-switched network to the packet-switched network after the user input is received.

14. The apparatus of claim 11, wherein:
the first network is a circuit-switched network and the second network is a packet-switched network;
the condition comprises the packet-switched network having improved coverage quality; and
the means for switching is configured to switch the voice call from the circuit-switched network to the packet-switched network using radio resource control (RRC) signaling.

15. The apparatus of claim 11, wherein the first network is a circuit-switched network and the second network is a packet-switched network, and wherein:
the packet-switched network is unavailable for the voice call when the voice call is initiated using the circuit-switched network; and
the condition comprises the circuit-switched network having a decreased coverage quality and the packet-switched network becoming available for the voice call.

16. An apparatus for wireless communication by a user equipment (UE), the apparatus comprising:
a memory; and
at least one processor coupled to the memory and configured to:
initiate a voice call using a first network;
determine that a condition exists; and
switch the voice call from the first network to a second network after the determination that the condition exists.

17. The apparatus of claim 16, wherein the first network is a packet-switched network and the second network is a circuit-switched network, and wherein the at least one processor is further configured to:
determine that a battery power level of the UE is lower than a threshold power level;
disable all data services other than the voice call when the battery power level of the UE is lower than the threshold power level;
determine that no data activity other than the voice call is being conducted; and
determine a first transmission power needed for the packet-switched network and a second transmission power needed for the circuit-switched network after determining that no data activity other than the voice call is being conducted,
wherein the condition comprises the second transmission power being less than the first transmission power.

18. The apparatus of claim 16, wherein the first network is a circuit-switched network, the second network is a packet-switched network, and the condition comprises the packet-switched network having improved coverage quality, and wherein the at least one processor is further configured to:
prompt a user to switch the voice call from the circuit-switched network to the packet-switched network after the determination that the condition exists; and
receive an input from the user to switch the voice call from the circuit-switched network to the packet-switched network,
wherein the at least one processor is configured to switch the voice call from the circuit-switched network to the packet-switched network after the user input is received.

19. The apparatus of claim 16, wherein:
the first network is a circuit-switched network and the second network is a packet-switched network;
the condition comprises the packet-switched network having improved coverage quality; and
the at least one processor is configured to switch the voice call from the circuit-switched network to the packet-switched network using radio resource control (RRC) signaling.

20. A computer program product for wireless communication by a user equipment (UE), the computer program product comprising:
a computer-readable medium comprising code for:
initiating a voice call using a first network;
determining that a condition exists; and
switching the voice call from the first network to a second network after the determination that the condition exists.
